(19) United States
(12) Patent Application Publication
(10) Pub. No.: US 2026/0228040 A1
(43) Pub. Date: Aug. 6, 2026

(54) PROCESSING PROGRAM MANAGEMENT DEVICE AND COMPUTER-READABLE STORAGE MEDIUM

(71) Applicant: FANUC CORPORATION, Yamanashi (JP)

(72) Inventors: Kazuyuki MIKAMI, Yamanashi (JP); Manabu SAITOU, Yamanashi (JP)

(21) Appl. No.: 19/152,443

(22) PCT Filed: Feb. 13, 2023
(86) PCT No.: PCT/JP2023/004870

§ 371 Date: Jul. 31, 2025

(51) Int. Cl. G06F 9/48

(52) U.S. Cl. CPC G06F 9/4881

(57) ABSTRACT

A processing program management device stores a processing program that is formatted as a series of divided management units, acquires a specific block number for the processing program, reads out block counts for the management units that are additional information about the management units, uses the block counts to search for the management unit that includes the specific block number, calculates a block count in order from the leading block of the management unit that includes the specific block number, and searches for the storage position of the block that corresponds to the specific block number.

### RELATED APPLICATIONS

The present application is a National Phase of International Application No. PCT/JP 2023/004870 filed Feb. 13, 2023.

### TECHNICAL FIELD

The present disclosure relates generally to a processing program management device and a computer-readable storage medium.

### BACKGROUND ART

Numerical controllers are used for machine tools. The numerical controllers analyze a processing program so as to conduct control based on “numerical values” in digital form, such as positions of a workpiece and a spindle, and tool speed. The processing program is formed by a collection of units called blocks. Block numbers are serial numbers that represent the blocks starting from the beginning of the processing program and indicate the location of the processing program.

The processing program can be edited by displaying an edit screen and inputting the program through a keyboard. The processing program can be edited block by block, so that a block can be rewritten during operation of a machine tool, for instance, to change the operation of the machine tool. For example, Patent Literature 1 discloses such a technique.

### PRIOR ART DOCUMENT

### Patent Literature

[Patent Literature 1] Japanese Patent Laid-Open Publication No. 2003-248507

### BRIEF DESCRIPTION OF THE DRAWINGS

FIG. 1 is a block diagram of a processing program management device;

FIG. 2 is a schematic diagram illustrating a format of the processing program;

FIG. 3 is a schematic diagram illustrating another format of the processing program;

FIG. 4 is a screen diagram of an edit screen of the processing program;

FIG. 5 is a flowchart illustrating a method for searching for blocks;

FIG. 6 illustrates the method for searching for the blocks;

FIG. 7 illustrates writing of the blocks;

FIG. 8 illustrates the method for searching for the blocks in the processing program converted into a format (1);

FIG. 9 illustrates the method for searching for the blocks in the processing program converted into a format (2);

FIG. 10 is a flowchart illustrating the method for searching for the blocks in the processing program converted into a format (3);

FIG. 11 illustrates the method for searching for the blocks in the processing program converted into the format (3); and

FIG. 12 is a hardware configuration diagram of the processing program management device.

### DETAILED DESCRIPTION

According to the disclosure, in searching for a block location in a processing program, a character indicating a block delimiter is counted as the number of blocks while reading a program string character by character from the beginning of the processing program, and a block number on the edit screen and the block location in a memory are searched. In such a search method, the longer the processing program, the longer the search takes.

Thus, there is a need for a technique to make the search for the block location more efficient in a processing program management.

A processing program management device according to the present disclosure includes: a processing program storage unit that stores a processing program in a format in which the program is divided into a set of management units; a block number acquisition unit that acquires a specific block number in the processing program; a management unit searching unit that reads the number of blocks in each management unit that is additional information about the management unit, and searches for a management unit that includes the specific block number by using the number of blocks; and a block searching unit that calculates block numbers in order from a block at the beginning of the management unit including the specific block number, and searches for a stored location of a block that corresponds to the specific block number.

### Mode for Carrying the Invention

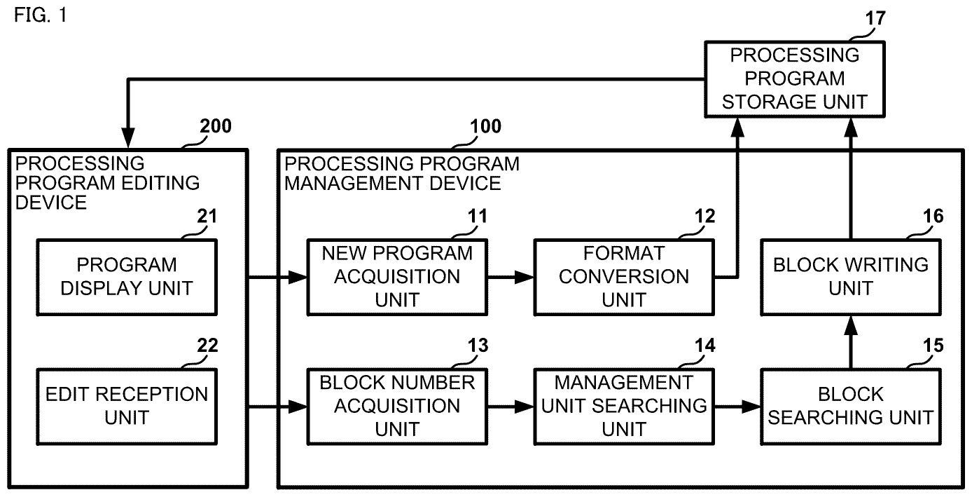

A description will now be made about a configuration of a processing program management device 100 by referring to FIG. 1. First, a relation between the processing program management device 100 and a processing program editing device 200 will be described.

The processing program management device 100 of the illustrative embodiment is configured to manage a processing program by dividing the program into management units. The processing program management device 100 is applied to an information processing device, such as a numerical controller.

The processing program editing device 200 includes a program display unit 21 and an edit reception unit 22, and thereby accepts an edit to a processing program conducted by a user and outputs a block number of the processing program to which the edit is accepted and the edited content to the processing program management device 100.

The processing program management device 100 converts the block number acquired from the processing program editing device 200 into a stored location in a processing program storage unit 17. The processing program management device 100 can rewrite the processing program block by block. It allows flexibility in operations, such as partial addition, change and deletion, without rewriting the entire processing program.

The processing program editing device 200 is implemented in a numerical controller, a personal computer (PC) and similar. The processing program management device 100 and the processing program editing device 200 may be implemented in a single device.

FIG. 1 is a block diagram of a processing program management device 100. The processing program management device 100 includes a new program acquisition unit 11, a format conversion unit 12, a block number acquisition unit 13, a management unit searching unit 14, a block searching unit 15, and a block writing unit 16.

The constituent elements of the processing program management device 100 are classified by function, and it is not necessary to be able to clearly distinguish these elements in terms of physical configuration and program composition.

The new program acquisition unit 11 is configured to acquire a new processing program which is not divided into management units. The new program is created by an editor of an information processing device, such as a numerical controller or PC. The new program may be acquired via a portable storage unit or network.

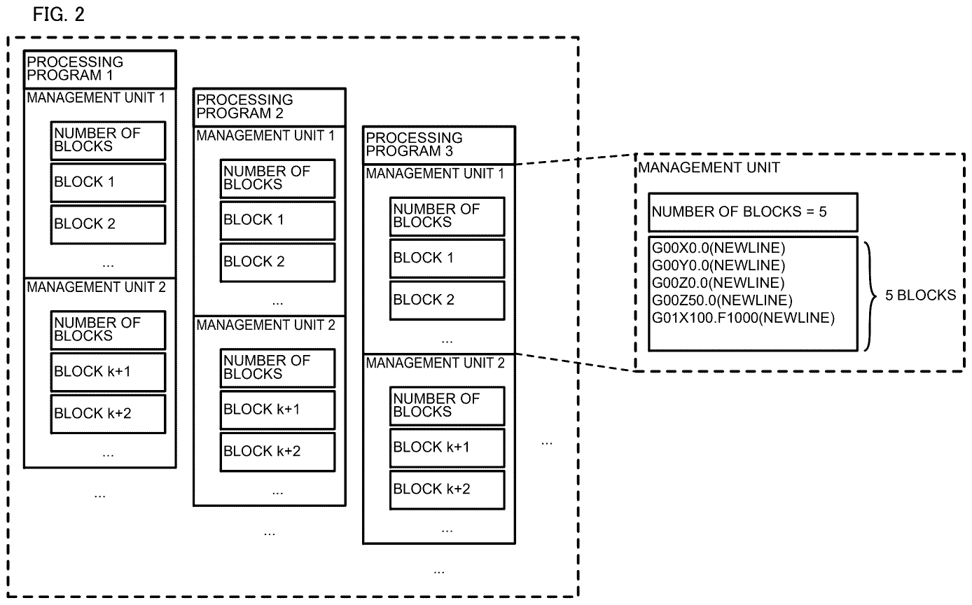

The format conversion unit 12 is configured to conduct format conversion on the acquired new program. In format conversion, the format conversion unit 12 divides the new program into predetermined management units. The predetermined management unit means a predefined size, such as a few kilobytes and a few megabytes. In here, this size is defined in advance. A management unit 1 of a processing program 3 shown in FIG. 2 includes five blocks.

The division of the processing program into the management units facilitates partial edit of the processing program. For example, in a case where the size of a management unit is exceeded due to the insertion of a block, a new management unit is added without rewriting the entire file. By dividing the program into management units, frequent edit, such as addition, change and deletion, can be performed.

The format conversion unit 12 divides the processing program into the management units and adds additional information about the number of blocks to each management unit. The number of blocks means the number of block delimiters in the management unit. The block delimiter is a specific character string that indicates the end of a block. As a block delimiter, a newline character is often used (CR=‘0x0D’, LF=‘0x0A’). The block delimiter may be any character code.

The format conversion unit 12 counts the block delimiters so that the characters composing the processing program can be associated with the block numbers. That is to say, one character is read at a time from the beginning of the processing program, and thus the block number of the block up to the first block delimiter is recognized as “1”, the block number of the block up to the second block delimiter is recognized as “2”, the block number of the block up to the third block delimiter is recognized as “3” and so on.

The format conversion unit 12 counts the block delimiters included in each management unit, and adds the count as additional information “number of blocks” to the management unit. For example, a management unit shown in FIG. 2 includes five block delimiters. The format conversion unit 12 adds additional information indicating the number of blocks “5” to the management unit.

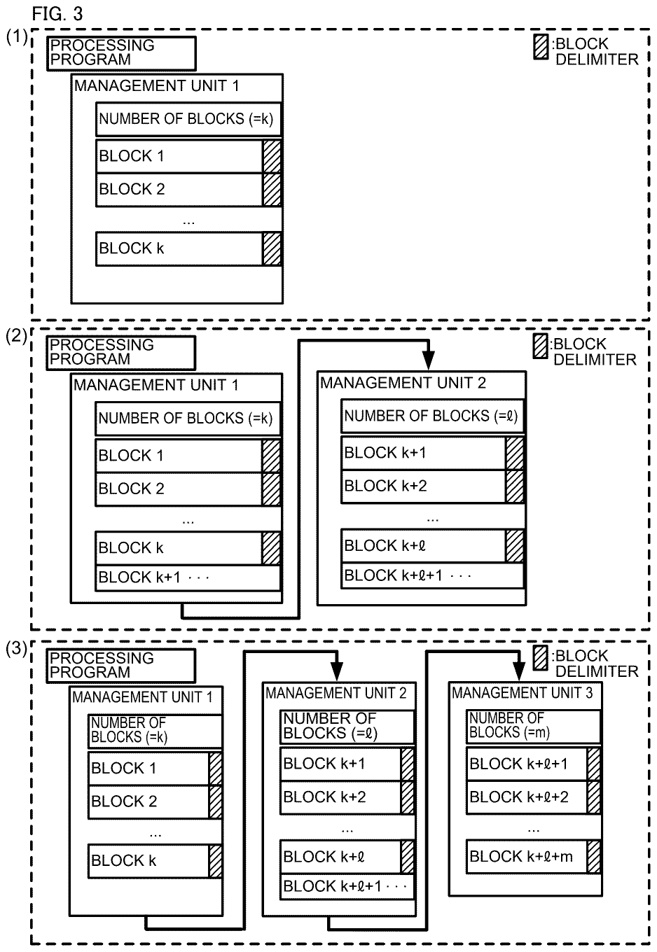

A description will now be made about the format of the processing program. For example, the format of the processing program includes, as shown in FIG. 3, a format (1) in which the block delimiter is arranged to be the last character of the management unit without dividing the block, a format (2) in which the block is divided such that the last block in the management unit extends across the next block, and a format (3) in which the format (1) and format (2) are mixed.

Format (1): in a case where the block delimiter is recorded to be the last character of the management unit without dividing the block, the number of block delimiters included in the management unit matches the number of blocks forming the management unit. Format (2): in a case where the block is divided such that the last block of the management unit extends across the next block and is recorded, there is a discrepancy between the number of block delimiters in the leading management unit and the number of blocks forming the leading management unit. Format (3): the method for searching and writing a block changes depending on which method is used. This will be described in another embodiment. The processing program management device 100 defines which method is to be used.

The block number acquisition unit 13 is configured to acquire block numbers from the processing program editing device 200. The processing program editing device 200 accepts a user operation on a processing program displayed on the program display unit 21, and output the block number of a block of the processing program accepted by the edit reception unit 22 and an editing content to the processing program management device 100.

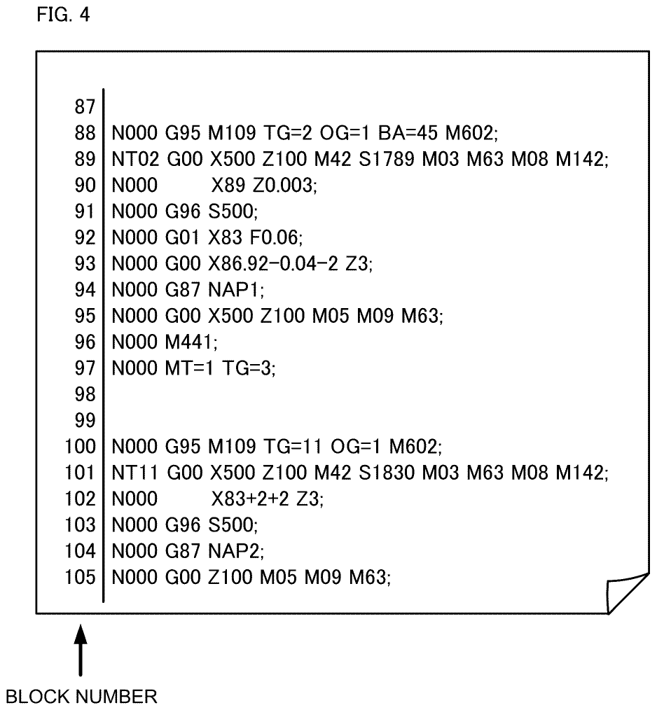

FIG. 4 shows an example of an edit screen in the processing program editing device 200. The edit screen in FIG. 4 displays the block number for each block in the processing program. The block number may or may not be displayed on the edit screen. The edit reception unit 22 of the processing program editing device 200 accepts the user operation. The block number acquisition unit 13 acquires the operation content accepted by the edit reception unit 22 and the block number to be operated.

The management unit searching unit 14 is configured to search for the management unit that includes the block having the block number acquired by the block number acquisition unit 13.

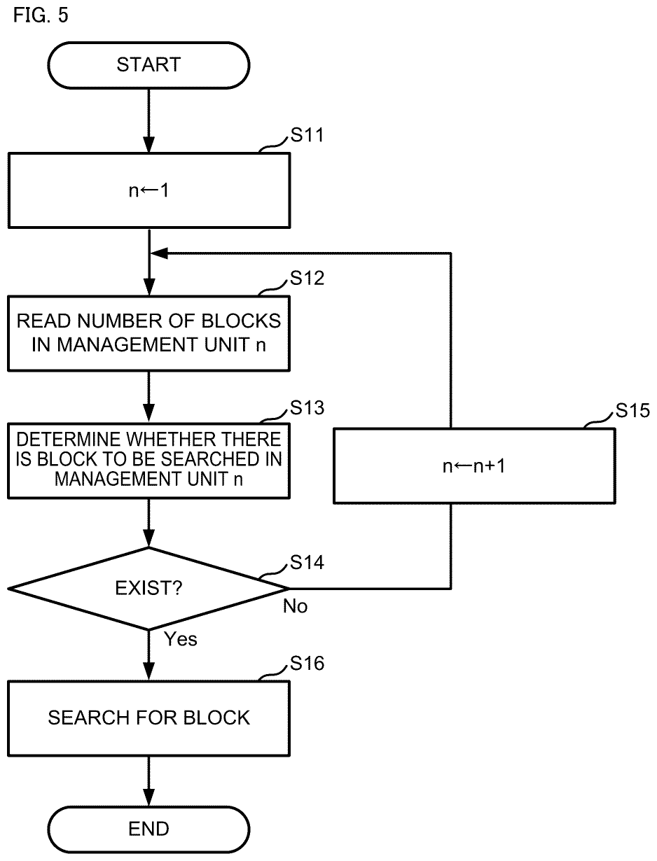

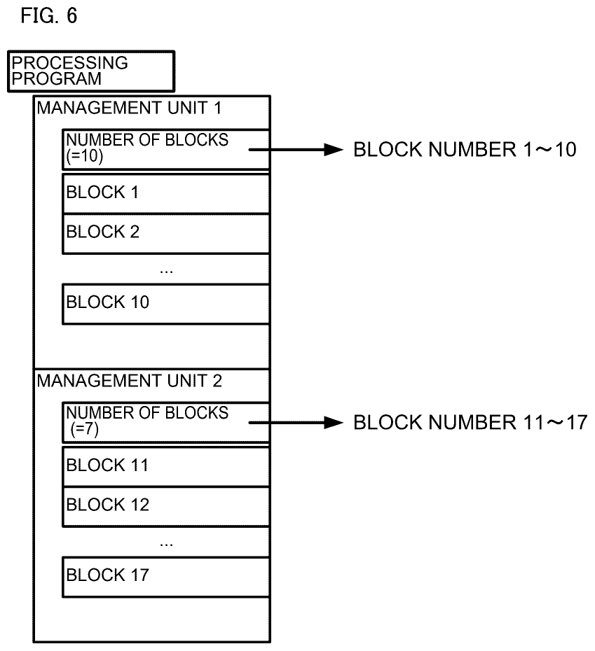

With reference to a flowchart of FIG. 5 and a diagram of FIG. 6, a method of searching for a block location will be described. The number of blocks is first read from the leading management unit 1. The management unit searching unit 14 first inputs a value of 1 into a management unit n (step S11), and reads out the number of blocks in the unit n (step S12).

The management unit searching unit 14 calculates the range of block numbers included in the management unit n based on the number of blocks and determines whether there is the block to be searched in the management unit n (step S13).

When there is the block to be searched in the management unit n (step S14: Yes), the management unit searching unit 14 conducts block search, about which will be described later. When there is no block to be searched in the management unit n (step S14: No), the management unit searching unit 14 inputs a value of n+1 into the unit number n to change the management unit n to be searched into the next management unit n+1 (step S15). The management unit searching unit 14 in turn moves to the step S12 to read out the number of blocks in the next management unit. The management unit searching unit 14 repeats the processes in the step S12 to the step S15 until the management unit that includes the block to be searched is detected.

The block searching unit 15 reads out the processing program character by character starting from the beginning of the management unit that includes the block to be searched, and determines whether or not the read-out character is a block delimiter. When the read-out character is the block delimiter, the block searching unit 15 increments the block number by 1. The value of this block number is the block number of a block next to the block delimiter most recently read out. The block searching unit 15 compares the calculated block number with the block number to be searched to associate the block number of the block to be searched with the location stored in the processing program storage unit 17.

A specific description will be made about the method of searching for the blocks by referring to FIG. 6.

First, a search is made for a management unit that includes the block to be searched. According to the example in FIG. 6, since the number of blocks in “management unit 1” is “10”, there are blocks with the block numbers “1 to 10” in “management unit 1”. The block number of the block to be searched is “12”, and thus there is no block to be searched in “management unit 1”.

The number of next blocks in “management unit 2″ is ”7″, and there are blocks with the block numbers “11 to 17”. Since the block number of the block to be searched is “12”, namely “11≤12≤17”, it is determined that there is the block to be searched in “management unit 2”.

The block searching unit 15 searches for the location of the block to be searched in the management unit. The block searching unit 15 compares the block number of the block at the beginning of “management unit 2” with the block number to be searched. The block number at the beginning of “management unit 2” is “11”. It does not match the block number “12” of the block to be searched. Thus, the block searching unit 15 reads the processing program of “management unit 2” character by character, and when there is a block delimiter, then increments the block number by 1. Since the block number is incremented by 1, the block number becomes “12 (=11+1)”. The block number “12” to be searched is the same as the block number of a character subsequent to the block delimiter. Thus, the block searching unit 15 can associate the block number to be searched that is acquired from the processing program editing device 200 with the location of the block stored in the processing program storage unit 17.

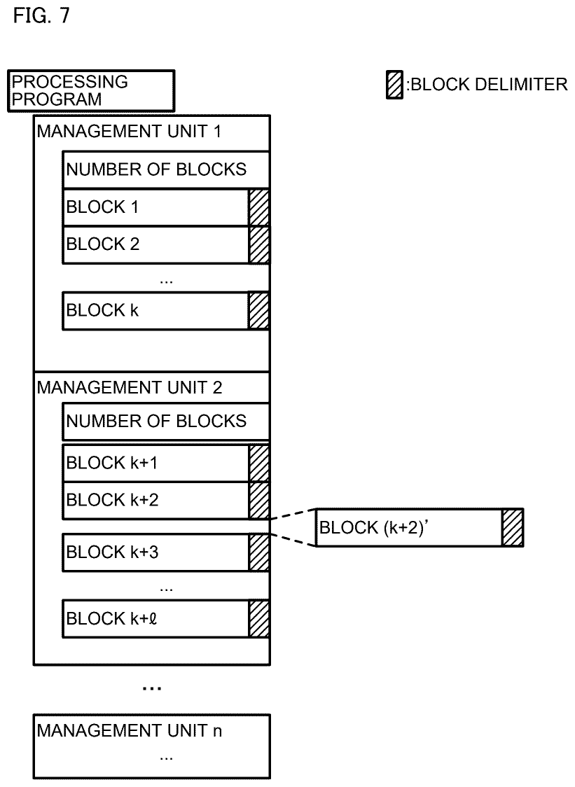

The block writing unit 16 updates an editing content conducted by the processing program editing device 200 so that the editing content is reflected in the processing program on the memory. The writing of the blocks will be described by referring to FIG. 7. In the example of FIG. 7, it is assumed that the number of blocks is “k” in “management unit 1” and the number of blocks is “l” in “management unit 2”. Furthermore, a block corresponding to a block number “k+2” is the object to be searched, and thus a block “(k+2)” is added after the number “k+2”.

After inserting the block, the block writing unit 16 adds the number of block delimiters that has increased due to the insertion of the block, and updates the number of blocks as additional information about the management unit.

An increase in the number of characters of the block and the insertion of the block by the edit may result in an excess of the size of the management unit. When the size of the management unit is exceeded, the block writing unit 16 adds a new management unit. When adding the new management unit, a block is written in any of the above-described formats (1), (2) and (3). The format to be used is defined in advance.

As described above, the processing program management device 100 manages the processing program by dividing it into the management units. The processing program management device 100 adds the number of blocks included in a management unit to each management unit. On the basis of the number of blocks added to the management unit, the processing program management device 100 can search which management unit the block to be searched is included in. The processing program management device 100 of the illustrative embodiment may read only the management unit that includes the block to be searched character by character from the beginning of this management unit to determine the number of blocks. Consequently, it is not necessary to make a determination character by character on the management units other than the management unit including the block to be searched, and the location of the block can be searched more efficiently.

In the determination about whether the block to be searched is included in the management unit or not, only the block number at the end of the management unit may be calculated. Taking the processing program in FIG. 6 as an example, the block number at the end of management unit 1 is “10”. Since the block number “12” to be searched is greater than the block number “10” at the end of management unit 1, it can be understood that the block to be searched is not included in management unit 1. The block number at the end of management unit 2 is “17”. The block number “12” to be searched is smaller than the block number “17” at the end of management unit 2, it can be seen that the block to be searched is included in management unit 2.

### Searching Method According to Each Format

The method of searching for blocks differs according to the format of the management unit. The difference in the searching methods between three formats (1), (2) and (3) will be described as below.

### (1) Format in Which the Last Character in Management Unit is Block Delimiter

The processing program is stored such that the last character in a management unit is to be the block delimiter, and thereby the number of blocks forming the management unit matches the number of blocks that is additional information about the management unit. The management unit searching unit 14 calculates the range of block numbers included in a management unit n by using the following method.

In the following description, the block number of the block at the beginning of the management unit n is referred to as FBN (First Block Number), a block number at the end of the management unit n is referred to as LBN (Last Block Number), and a block number to be searched is referred to as TN (target number).

The range of block numbers included in the management unit n is between the block number FBN of the block at the beginning and the block number LBN of the block at the end. Assuming that the number of blocks in the management unit n is “m”, the block number FBN of the block at the beginning of the management unit n is obtained by adding a value of 1 to the sum of the number of blocks up to a management unit n−1 that is one before the management unit n. The block number LBN of the block at the end of the management unit n is a value obtained by adding the number of blocks “m” in the management unit n to the sum of the number of blocks up to the management unit n−1 that is one before the management unit n.

The management unit searching unit 14 searches for the management unit that includes the block number TN in order from the leading management unit 1. In this search, the management unit searching unit 14 first calculates the block number FBN at the beginning and the block number LBN at the end of the leading management unit 1 so as to compare them with the block number TN to be searched. When the block number TN to be searched is not included in the management unit 1, the management unit searching unit 14 in turn calculates the block number FBN at the beginning and the block number LBN at the end of the management unit 2 to thereby compare them with the block number TN to be searched. When the block number TN to be searched is not included in the management unit 2, the management unit searching unit 14 calculates the block number FBN at the beginning and the block number LBN at the end of the next management unit. The management unit searching unit 14 repeats the same processes to search for the management unit that includes the block number TN to be searched.

The block searching unit 15 searches for the block to be searched. The block searching unit 15 first compares the block number FBN at the beginning of the management unit that includes the block to be searched with the block number TN of the block to be searched. When the comparison result shows that the block number TN of the block to be searched is greater than the block number FBN of the block at the beginning of the management unit, the block searching unit 15 reads the next character. When the next character is a block delimiter, the block searching unit 15 increments the block number at the beginning by 1, and compares it with the block number TN to be searched. When the next character is not the block delimiter, the block searching unit 15 reads the subsequent character. The block searching unit 15 repeats these processes until the block number of the read-out character matches the block number TN to be searched.

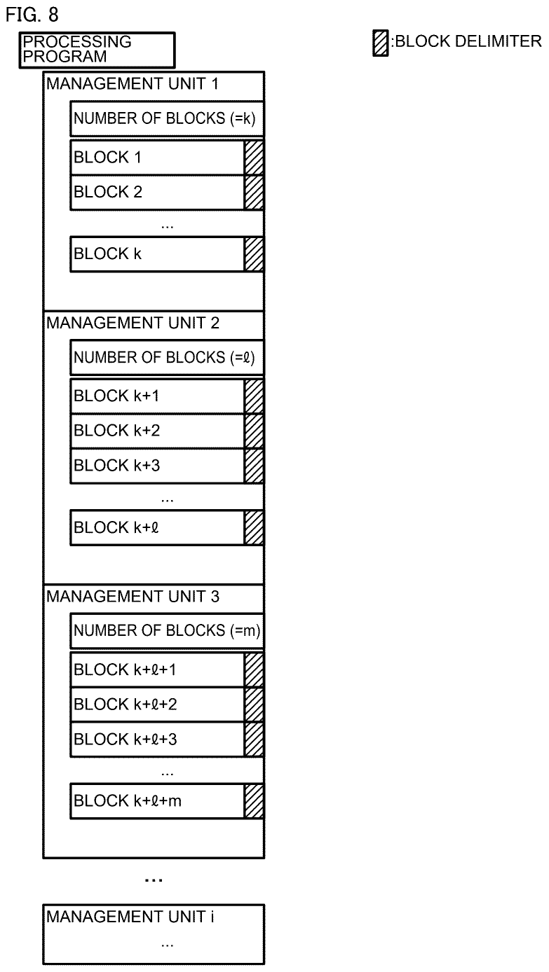

With reference to FIG. 8, a specific description will be made about the method of searching for blocks. In the example of FIG. 8, the number of blocks in management unit 1 is “k”, the number of blocks in the management unit 2 is “l”, the number of blocks in the management unit 3 is “m”, and the block number TN of the block to be searched is “k+l+2”.

The management unit searching unit 14 first calculates the block number FBN at the beginning and the block number LBN at the end of the leading management unit 1. The block number FBN at the beginning of the management unit 1 is “1”, and the block number LBN at the end is “k”. The block number TN to be searched, namely “k+l+2”, is not within this range. When the block to be searched is not included in the management unit 1, the management unit searching unit 14 calculates the range of block numbers included in the next management unit 2.

The block number FBN at the beginning of the management unit 2 is “a value obtained by adding a value of 1 to the number of blocks k in the management unit 1”, that is, “k+1”. The block number LBN at the end of the management unit 2 is the value “k+1” that is obtained by adding the number of blocks “1” in the management unit 2 to “the number of blocks k in the management unit 1”. When the block to be searched is not included in the management unit 2, the management unit searching unit 14 determines that the block to be searched is not included in the management unit 2, and in turn calculates the range of block numbers in the next management unit 3.

The block number FBN at the beginning of the management unit 3 is “a value obtained by adding the value of 1 to the sum of the number of blocks in the management unit 1 and the management unit 2”, namely “k+l+1”. The block number LBN at the end of the management unit 3 is a value “k+l+m” that is obtained by adding the number of blocks “m” in the management unit 3 to the sum “k+1” of the number of blocks in the management unit 1 and the management unit 2. The block number TN “k+l+2” to be searched is within the above range. The management unit searching unit 14 determines that the management unit that includes the block to be searched is the management unit 3.

The block searching unit 15 searches for the block to be searched. The block searching unit 15 reads one character at a time from the beginning of the management unit 3 to search for a block delimiter. When a read-out character is the block delimiter, the block searching unit 15 increments the block number by 1. When the calculated block number is identical with the block number TN to be searched, the block searching unit 15 determines that a character after the block delimiter read out most recently is the character at the beginning of the block to be searched. Thus, the block number to be searched can be associated with the location of the block to be searched stored in the processing program storage unit 17.

In the example of FIG. 8, when the block delimiter is detected, the block searching unit 15 adds the value of 1 to the block number “k+l+1” at the beginning of the management unit 3, and calculates the block number “k+l+2” of the next block. The block number “k+l+2” thus calculated is identical with the block number “k+l+2” to be searched. In this way, the location of the block number “k+l+2” to be searched in the processing program storage unit 17 can be found.

The above-described processing program management device 100 stores the processing program such that the last character in the management unit is to be the block delimiter. Consequently, the number of blocks forming the management unit matches the number of blocks as the additional information about the management unit (the number of block delimiters included in the management unit). The processing program management device 100 uses the above-described method to calculate the range of block numbers included in the management unit so as to search in which management unit the block to be searched is included.

### (2) Format in Which Last Block in Management Unit Extends Across Next Block

In the format (2), there is a discrepancy between the number of blocks as the additional information about the management unit (number of block delimiters included in the management unit) and the number of blocks included in the management unit. The last block in the management unit n is divided into two and recorded extending across the next management unit n+1, so that the number of blocks included in the management unit n is greater than the number of blocks (the number of block delimiters) by a discrepancy “1”.

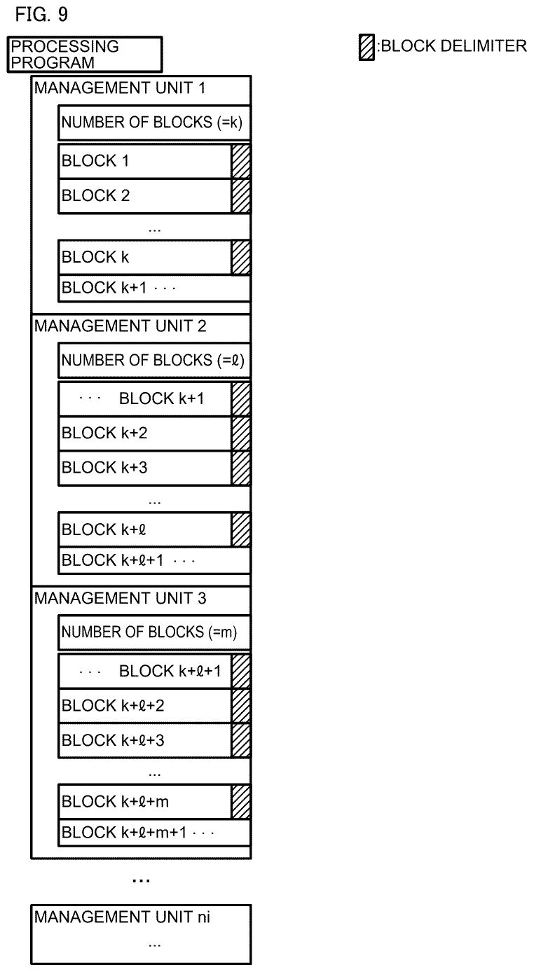

In the format (2), the block number LBN at the end of the management unit is incremented by 1 in order to compensate for the discrepancy in the number of blocks between the management units. In an example shown in FIG. 9, when the number of blocks in the management unit n is “m”, the block number of the block at the end of the management unit n has a value obtained by adding the number of blocks “m” in the management unit n and the discrepancy “1” in the number of blocks to the sum of the number of blocks up to the management unit n−1 that is one before the management unit n. In this way, the range of block numbers of the block included in each management unit can be calculated.

A specific description will be made about the method of searching for blocks by referring to FIG. 9. In the example shown in FIG. 9, the number of blocks in the management unit 1 is “k”, the number of blocks in the management unit 2 is “l”, the number of blocks in the management unit 3 is “m”, and the block number TN of the block to be searched is “k+l+2”.

The management unit searching unit 14 first calculates the block number FBN at the beginning and the block number LBN at the end of the leading management unit 1. The block number FBN at the beginning of the management unit 1 is “1”, and the block number LBN at the end is “k+1” that is obtained by adding the discrepancy “1” in the number of blocks to the number of blocks “k”. Since the block number TN “k+l+2” to be searched is not within this range, the management unit searching unit 14 determines that the block to be searched is not included in the management unit 1 and calculates the range of block numbers included in the management unit 2.

The block number FBN at the beginning of the management unit 2 is “a value obtained by adding the value 1 to the number of blocks k in the management unit 1”, that is, “k+1”. The block number at the end of the management unit 2 is a value that is obtained by adding “1” to the sum of the number of blocks in the management unit 1 and the management unit 2, that is, “k+l+1”. Since the block number “k+l+2” to be searched is not within this range, the management unit searching unit 14 calculates the range of block numbers included in the next management unit 3.

The block number FBN at the beginning of the management unit 3 is “a value obtained by adding the value 1 to the sum of the number of blocks in the management unit 1 and the management unit 2”, namely “k+l+1”. The block number LBN at the end of the management unit 3 is a value “k+l+m+1” that is obtained by adding the number of blocks “m” in the management unit 3 and the discrepancy “1” in the number of blocks to “the sum of the number of blocks in the management unit 1 and the management unit 2”. The block number “k+l+2” to be searched is within the range of the management unit 3. The management unit searching unit 14 determines that the management unit that includes the block to be searched is the management unit 3.

The block searching unit 15 searches for the location of the block number TN to be searched in the management unit 3. The block searching unit 15 reads one character at a time from the beginning of the management unit 3, and when a read-out character is a block delimiter, then adds the value “1” to the current block number. The block searching unit 15 determines whether or not the block number TN to be searched is identical with the calculated block number. When the two block numbers are identical with each other, the block searching unit 15 determines that a character after the block delimiter read out most recently is the first character of the block to be searched.

The above-described processing program management device 100 divides the block such that the last block in the management unit extends across the next block, and stores the divided block. In the format (2), the processing program can be recorded without gaps in the management unit, thereby eliminating a wasteful capacity. In the searching method according to the format (2), the management unit search unit 14 can calculate the range of block numbers included in the management unit by simply adding the discrepancy “1”, as with the case of the format (1), so that the load to conducting the calculation is low and efficient. However, since the block is adjusted to extend across two management units in the format (2), it may be necessary to insert a garbage character when the processing program is recorded.

### Format (3) in Which Formats (1) and (2) are Mixed

In a case where the formats (1) and (2) are mixed, a determination condition is changed depending on whether the last character in a management unit is a block delimiter or not,

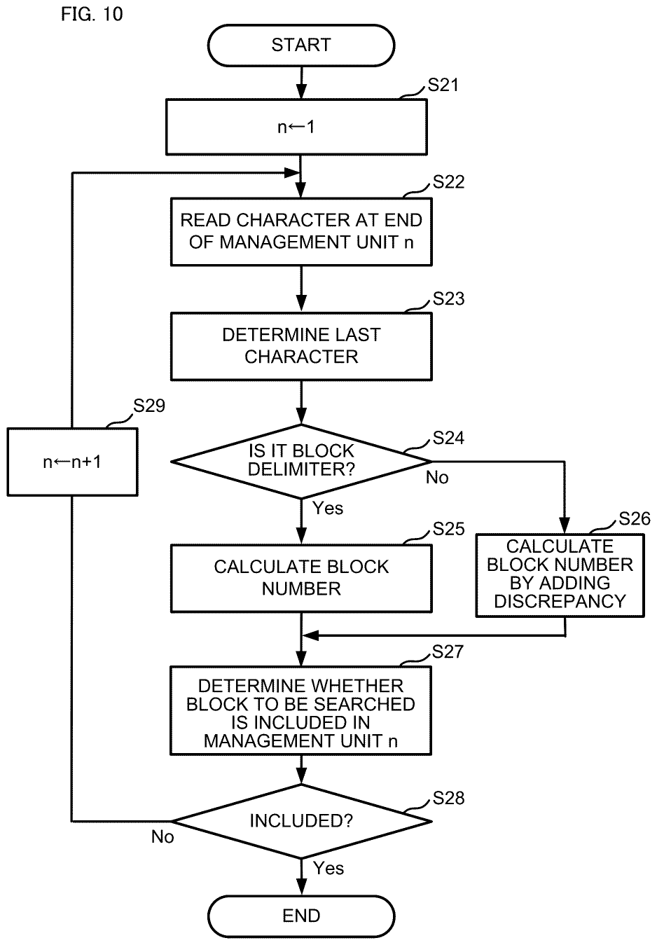

FIG. 10 is a flowchart showing an operation of the processing program management device in the format (3).

When the range of block numbers included in the management unit n is calculated (step S21), the management unit searching unit 14 first reads the last character in the management unit n (step S22), and determines whether the last character is a block delimiter or not (step S23). When the last character is the block delimiter (step S24: Yes), there is no discrepancy between the number of blocks (number of block delimiters) that is additional information about the management unit n and the number of blocks included in the management unit n, and it is not necessary to compensate the discrepancy. The management unit searching unit 14 adds the number of blocks “m” in the management unit n to the sum of the number of blocks up to the management unit n−1 that is one before the management unit n to thereby calculate the block number LBN of the block at the end of the management unit n (step S25).

When the last character in the management unit n is not the block delimiter (step S24: No), there is a discrepancy between the number of blocks (number of block delimiters) that is the additional information about the management unit n and the number of blocks included in the management unit n. The management unit searching unit 14 adds the sum of the number of blocks up to the management unit n−1 which is one before the management unit n, the number of blocks “m” in the management unit n, and the discrepancy “1” between the number of blocks, so as to calculate the block number LBN of the block at the end of the management unit n (step S26).

The management unit searching unit 14 determines whether the block having the block number TN to be searched is included in the range of the management unit n (step S27). When the block having the block number TN to be searched is not included in the management unit n (step S28: No), the management unit searching unit 14 moves to the step S22 and inputs n+1 into the unit number n to change the management unit n to the next management unit n+1 (step S29).

When the block having the block number TN to be searched is included in the management unit n (step S28: Yes), the management unit searching unit 14 determines that the block to be searched is included in the management unit n.

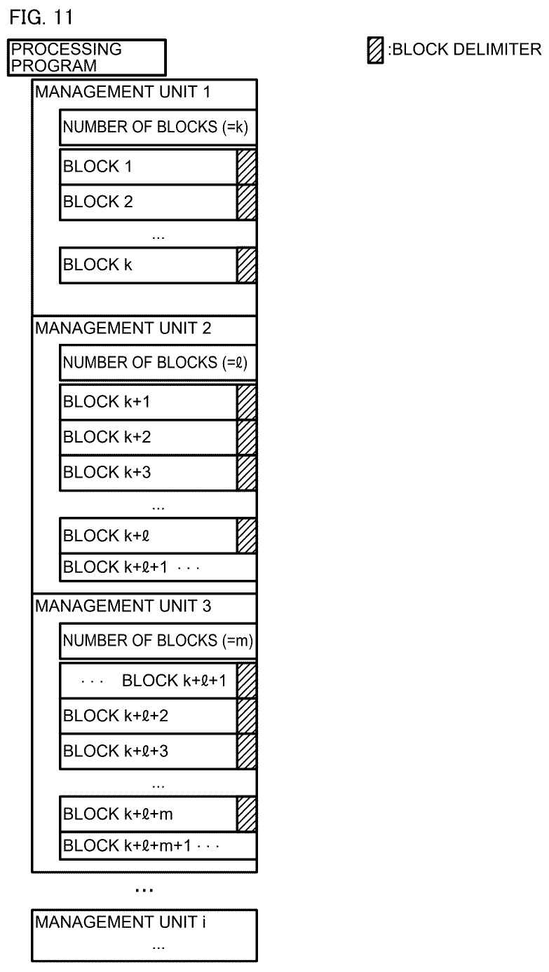

With reference to FIG. 11, a specific description will be made about the method of searching for the management unit according to the format (3). In the example in FIG. 11, the number of blocks in the management unit 1 is “k”, the number of blocks in the management unit 2 is “l”, and the number of blocks in the management unit 3 is “m”.

The management unit searching unit 14 reads the last character in the leading management unit 1 and determines whether the last character is a block delimiter or not. The last character in the management unit 1 in FIG. 11 is the block delimiter. The management unit searching unit 14 then calculates a block number LBN “k” of the block at the end of the management unit 1. The management unit searching unit 14 compares the block number LBN “k” of the block at the end of the management unit 1 with the block number TK “k+l+2” to be searched, and determines that the block to be searched is not included in the management unit 1.

The management unit searching unit 14 reads the last character in the next management unit 2 to determine whether the last character in the management unit 2 is a block delimiter or not. The last character in the management unit 2 shown in FIG. 11 is not the block delimiter. The management unit searching unit 14 then adds the number of blocks “l” in the management unit 2 and the discrepancy “1” to the number of blocks “k” in the management unit 1, thereby calculating the block number LBK “k+l+1” of the block at the end of the management unit 2. The management unit searching unit 14 compares the block number LBN “k+l+1” of the block at the end of the management unit 2 with the block number TK “k+l+2” to be searched, and determines that the block to be searched is not included in the management unit 2.

The management unit searching unit 14 reads the next management unit 3 to determine whether the last character in the management unit 3 is a block delimiter or not. The last character in the management unit 3 in FIG. 11 is not the block delimiter. The management unit searching unit 14 then adds the number of blocks “m” in the management unit 3 and the discrepancy “1” to the sum “k+1” of the number of blocks in the management unit 1 and the management unit 2 to thereby calculate the block number LBK “k+l+m+1” of the block at the end of the management unit 3. The management unit searching unit 14 compares the block number LBK “k+l+m+1” at the end of the management unit 3 with the block number TK “k+l+2” to be searched, and determines that the block to be searched is included in the management unit 3.

In the format (3), there is a mixture of the case where a discrepancy occurs at the end of the management unit and the case where no discrepancy occurs. The processing program management device 100 compensates the discrepancy by adding the value “1” to the block number at the end of the management unit when the last character is not the block delimiter, and does not compensate the discrepancy when the last character in the management unit is the block delimiter.

The searching method of the format (3) is highly versatile because it can be applied to both the format (1) and the format (2). Since the format (3) enables recording processing program without gaps, there is no waste. Furthermore, it is not necessary to adjust the location of the block delimiter in the format (3). However, since the searching method according to the format (3) determines whether or not to compensate the discrepancy when searching for the management unit, there is a problem of the increase in the amount of calculation compared with the formats (1) and (2).

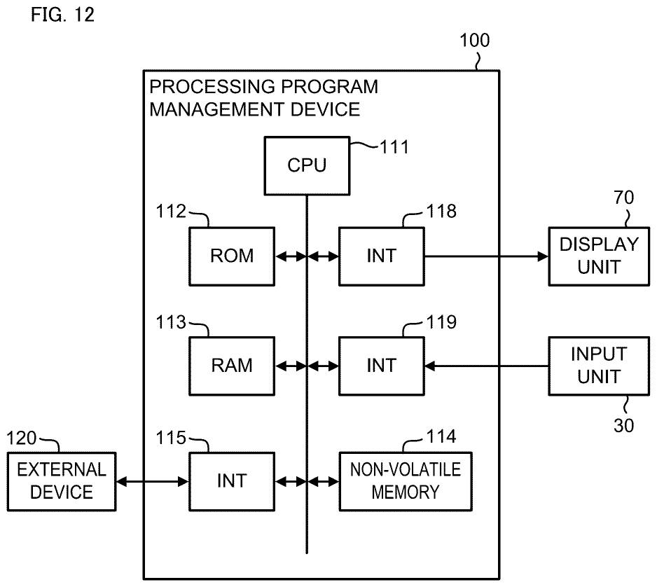

Now, a description will be made about a hardware configuration of the processing program management device 100 to which the present disclosure is applied. FIG. 12 is a hardware configuration diagram of the processing program management device 100. The processing program management device 100 includes, as shown in FIG. 12, a central processing unit (CPU) 111 configured to control the entire processing program management device 100, a read-only memory (ROM) 112 configured to store programs and pieces of data, and a random-access memory (RAM) 113 configured to temporarily expand data. The CPU 111 reads a system program stored in the ROM 112 via a bus to conduct processing program management.

A non-volatile memory 114 is backed up by a battery not shown, for example, so that storage conditions can be retained even when a power source of the processing program management device 100 is turned off. The non-volatile memory 114 is configured to store programs read from an external device 120 via interfaces 115, 118 and 119, and various data about user operations and others, input through an input device 30. The non-volatile memory 114 may store programs and pieces of data for conducting block search according to the present disclosure. Furthermore, a display unit 70 is provided to display various data.

The interface 115 is configured to connect the processing program management device 100 to the external device 120, such as an adaptor. From the external device 120, programs, parameters and others can be read out.

The present disclosure has been described in detail as above, but is not limited to the above-described individual embodiments. Thus, various additions, substitutions, modifications, partial deletions and so on may be made to these embodiments without departing from the gist of the present disclosure or the spirit of the present disclosure as derived from the contents described in the appended claims and their equivalents. Furthermore, these embodiments can be implemented by combining them. For example, the order of the operations and the order of the processes in these embodiments are provided by way of example, and thus are not limited thereto.

Supplementary notes on the above-described embodiments and their variations will be presented below.

### Supplementary Note 1

A processing program management device (100) includes: a processing program storage unit (17) that stores a processing program in a format in which the program is divided into a set of management units; a block number acquisition unit (13) that acquires a specific block number in the processing program; a management unit searching unit (14) that reads the number of blocks in a management unit that is additional information about the management unit, and by using the number of blocks, searches for a management unit that includes the specific block number; and a block searching unit (15) that calculates block numbers in order from a block at the beginning of the management unit that includes the specific block number so as to search for a stored location of a block that corresponds to the specific block number.

### Supplementary Note 2

In the processing program management device (100), the block number acquisition unit (13) includes a block writing unit (16) that acquires an editing content of the block indicated by the specific block number, edits a block included in the management unit based on the editing content, and updates the number of blocks that is the additional information about the management unit.

### Supplementary Note 3

In the processing program management device (100), when the management unit exceeds a predetermined size due to editing, the block writing unit (16) adds a new management unit and then writes an excess editing content into the new management unit.

### Supplementary Note 4

The processing program management device (100) includes: a new program acquisition unit (11) that acquires a new processing program that is not divided into management units; and a format conversion unit (12) that divides the new processing program into a set of management units, counts the number of blocks included in each management unit, and adds the number of blocks to each management unit as additional information.

### Supplementary Note 5

In the processing program management device (100), the number of blocks is the number of block delimiters included in each management unit, and in the set of management units, the last block in each management unit is divided to extend across the next block, and the management unit searching unit (14) increments the number of blocks as the additional information about the management unit by 1 so as to compensate a discrepancy between the number of blocks as the additional information and the number of blocks included in the management unit.

### Supplementary Note 6

In the processing program management device (100), the number of blocks is the number of block delimiters included in each management unit, and the management unit searching unit (14) determines whether or not the last character in the management unit is a block delimiter, and when the last character is not the block delimiter, increments the number of blocks by 1 to compensate a discrepancy between the number of blocks as the additional information and the number of blocks included in the management unit.

### Supplementary Note 7

A Computer-readable storage medium (112, 113, 114) is for, by execution by one or more processors (111), storing a processing program in a format, in which the program is divided into a set of management units, in a predetermined storage area, acquiring a specific block number in the processing program, reading the number of blocks in a management unit that is additional information about the management unit, searching for a management unit that includes the specific block number by using the number of blocks, calculating the block number in order from the block at the beginning of the management unit that includes the specific block number, and searching for a stored location of a block that corresponds to the specific block number.

1. A processing program management device, comprising:
a processing program storage unit that stores a processing program in a format in which the program is divided into a set of management units;
a block number acquisition unit that acquires a specific block number in the processing program;
a management unit searching unit that reads the number of blocks in each management unit that is additional information about the management unit, and searches for a management unit that includes the specific block number by using the number of blocks; and
a block searching unit that calculates block numbers in order from a block at the beginning of the management unit that includes the specific block number, and searches for a stored location of a block that corresponds to the specific block number.

2. The processing program management device according to claim 1, wherein the block number acquisition unit acquires an editing content of the block indicated by the specific block number, and comprises:
a block writing unit that edits the block included in the management unit based on the editing content, and updates the number of blocks that is the additional information about the management unit.

3. The processing program management device according to claim 2, wherein when the management unit exceeds a predetermined size due to editing, the block writing unit adds a new management unit, and then writes an excess editing content into the new management unit.

4. The processing program management device according to claim 1, comprising:
a new program acquisition unit that acquires a new processing program that is not divided into management units; and
a format conversion unit that divides the new processing program into a set of management units, counts the number of blocks included in each management unit, and adds the number of blocks to each management unit as additional information.

5. The processing program management device according to claim 1, wherein the number of blocks is the number of block delimiters included in each management unit,
in the set of management units, the last block in each management unit is divided to extend across the next block, and
the management unit searching unit increment the number of blocks as the additional information about the management unit by 1, so as to compensate a discrepancy between the number of blocks as the additional information and the number of blocks included in the management unit.

6. The processing program management device according to claim 1, wherein the number of blocks is the number of block delimiters included in each management unit, and
the management unit searching unit determines whether a last character in the management unit is a block delimiter or not, and when the last character in the management unit is not the block delimiter, increments the number of blocks by 1, so as to compensate the discrepancy between the number of blocks as the additional information and the number of blocks included in the management unit.

7. A computer-readable storage medium that stores commands that cause one or more processors to execute steps of:
storing a processing program in a format in which the program is divided into a set of management units in a predetermined storage area;
acquiring a specific block number in the processing program;
reading the number of blocks in each management unit that is additional information about the management unit, and searching for a management unit that includes the specific block number by using the number of blocks; and
calculating block numbers in order from a block at the beginning of the management unit that includes the specific block number, and searching for a stored location of a block that corresponds to the specific block number.
